(19) United States
(12) Patent Application Publication
(10) Pub. No.: US 2024/0061010 A1
(43) Pub. Date: Feb. 22, 2024

(54) ACCELERATION SENSOR

(71) Applicant: ROHM CO., LTD., Kyoto (JP)

(72) Inventor: Hiroki MIYABUCHI, Kyoto (JP)

(73) Assignee: ROHM CO., LTD., Kyoto (JP)

(21) Appl. No.: 18/488,817

(22) Filed: Oct. 17, 2023

Related U.S. Application Data
(63) Continuation of application No. PCT/JP2022/022349, filed on Jun. 1, 2022.

(30) Foreign Application Priority Data
Jun. 16, 2021 (JP) 2021-100296

(51) Int. Cl. G01P 15/125; G01P 15/18

(52) U.S. Cl. CPC G01P 15/125; G01P 15/18; G01P 2015/0868

(57) ABSTRACT

An acceleration detecting portion that detects an acceleration in a predetermined direction and an offset detecting portion that detects an offset amount with respect to the acceleration detecting portion are included. The offset detecting portion includes a second semiconductor substrate with a second cavity formed in its interior, a second fixed structure including a second fixed electrode that is supported, in a state of floating with respect to the second cavity, by the second semiconductor substrate, a second movable structure including a second movable electrode that is supported, in a state of floating with respect to the second cavity, by the second semiconductor substrate, and a disabling structure that disables a function of the second movable electrode displacing with respect to the second fixed electrode.

### CROSS REFERENCE TO RELATED APPLICATIONS

The present application is a bypass continuation of International Patent Application No. PCT/JP2022/022349, which corresponds to Japanese Patent Application No. 2021-100296 filed on Jun. 16, 2021 with the Japan Patent Office, and the entire disclosure of this application is incorporated herein by reference.

### TECHNICAL FIELD

The present disclosure relates to an acceleration sensor.

### BACKGROUND ART

Acceleration sensors for measuring an acceleration that acts on an object are widely used to ascertain, for example, an orientation or movement, vibration state, etc., of an object. Also, with acceleration sensors, there is a strong demand for miniaturization. To answer such a demand, miniaturization of acceleration sensors is being carried out using so-called MEMS (micro electro mechanical system) technology. For example, an acceleration sensor of an electrostatic capacitance type that uses MEMS technology is disclosed in Japanese Patent Application Publication No. 2019-49434.

A sensor portion of the acceleration sensor described in Japanese Patent Application Publication No. 2019-49434 is formed by processing a semiconductor substrate. With such an acceleration sensor, an offset amount changes due to a temperature change. A detection error may thus occur due to the temperature change. It is assumed that application of stress to the semiconductor substrate due to the temperature change is a cause of the offset amount changing due to the temperature change.

The aforementioned as well as yet other objects, features, and effects of the present disclosure will be made clear by the following description of the preferred embodiments made with reference to the accompanying drawings.

### BRIEF DESCRIPTION OF DRAWINGS

FIG. 1 is an illustrative plan view showing an acceleration sensor according to a first preferred embodiment of the present disclosure.

FIG. 2 is an illustrative plan view showing an X-axis sensor.

FIG. 3 is an enlarged plan view of principal portions of FIG. 2.

FIG. 4 is an enlarged illustrative sectional view taken along line IV-IV of FIG. 3.

FIG. 5 is an enlarged plan view of principal portions of an X-axis offset detecting portion.

FIG. 6 is an enlarged illustrative plan view of principal portions showing a first Z-axis sensor.

FIG. 7 is an enlarged plan view of principal portions of FIG. 6.

FIG. 8 is an enlarged plan view of principal portions of a first Z-axis offset detecting portion.

FIG. 9 is an enlarged plan view of principal portions of a second Z-axis sensor.

FIG. 10 is an enlarged plan view of principal portions of a second Z-axis offset detecting portion.

FIG. 11 is a schematic view showing positional relationships in a Z-axis direction of fixed electrodes and movable electrodes of Z-axis sensors when an acceleration in the Z-axis direction is acting and positional relationships in the Z-axis direction of the fixed electrodes and the movable electrodes of the Z-axis sensors when an acceleration in the Z-axis direction acts.

FIG. 12 is an illustrative plan view showing an acceleration sensor according to a second preferred embodiment of the present disclosure.

FIG. 13 is an illustrative plan view showing an acceleration sensor according to a third preferred embodiment of the present disclosure.

FIG. 14 is an illustrative plan view showing an acceleration sensor according to a fourth preferred embodiment of the present disclosure.

### DESCRIPTION OF EMBODIMENTS

A preferred embodiment of the present disclosure provides an acceleration sensor including an acceleration detecting portion that detects an acceleration in a predetermined direction and an offset detecting portion that detects an offset amount with respect to the acceleration detecting portion and where the acceleration detecting portion includes a first semiconductor substrate with a first cavity formed in its interior, a first fixed structure including a first fixed electrode that is supported, in a state of floating with respect to the first cavity, by the first semiconductor substrate, and a first movable structure including a first movable electrode that is supported, in a state of floating with respect to the first cavity, by the first semiconductor substrate via an elastic structure and is a first movable electrode displacing in the predetermined direction with respect to the first fixed electrode, and the offset detecting portion includes a second semiconductor substrate with a second cavity formed in its interior, a second fixed structure including a second fixed electrode that is supported, in a state of floating with respect to the second cavity, by the second semiconductor substrate, a second movable structure including a second movable electrode that is supported, in a state of floating with respect to the second cavity, by the second semiconductor substrate, and a disabling structure that disables a function of the second movable electrode displacing with respect to the second fixed electrode.

With this arrangement, a detection error based on a temperature change can be reduced.

In the preferred embodiment of the present disclosure, the first semiconductor substrate and the second semiconductor substrate are arranged from a single semiconductor substrate that integrally includes the two and the first cavity and the second cavity are formed in an interior of the single semiconductor substrate.

In the preferred embodiment of the present disclosure, a shape and a size of the second fixed electrode are the same as a shape and a size of the first fixed electrode, and a shape and a size of the second movable electrode are the same as a shape and a size of the first movable electrode.

In the preferred embodiment of the present disclosure, the first fixed electrode includes a pair of first fixed electrodes that extend in parallel to each other at an interval in a predetermined direction, the first movable electrode includes a pair of first movable electrodes that are disposed between the pair of first fixed electrodes and extend in parallel to each other at an interval in the predetermined direction, the second fixed electrode includes a pair of second fixed electrodes that extend in parallel to each other at an interval in the predetermined direction, and the second movable electrode includes a pair of second movable electrodes that are disposed between the pair of second fixed electrodes and extend in parallel to each other at an interval in the predetermined direction.

In the preferred embodiment of the present disclosure, the first fixed electrode includes a plurality of first fixed electrodes that are formed in a comb-teeth shape in plan view, the first movable electrode includes a plurality of first movable electrode pairs that are formed in a comb-teeth shape in plan view, the plurality of first movable electrode pairs are disposed such as to contactlessly mesh with the plurality of first fixed electrodes, each first movable electrode pair includes two of the first movable electrodes that respectively face the first fixed electrodes at respective sides of the first movable electrode pair and extend in parallel to each other, the second fixed electrode includes a plurality of second fixed electrodes that are formed in a comb-teeth shape in plan view, the second movable electrode includes a plurality of second movable electrode pairs that are formed in a comb-teeth shape in plan view, the plurality of second movable electrode pairs are disposed such as to contactlessly mesh with the plurality of second fixed electrodes, and each second movable electrode pair includes two of the second movable electrodes that respectively face the second fixed electrodes at respective sides of the second movable electrode pair and extend in parallel to each other.

In the preferred embodiment of the present disclosure, the first fixed structure includes a first fixed base portion that is supported by the first semiconductor substrate and the plurality of first fixed electrodes that are formed in the comb-teeth shape with respect to the first fixed base portion, the first movable structure includes a first movable base portion and the plurality of first movable electrode pairs that are formed in the comb-teeth shape with respect to the first movable base portion, the first movable base portion is supported by the first fixed base portion via the elastic structure, the second fixed structure includes a second fixed base portion that is supported by the second semiconductor substrate and the plurality of second fixed electrodes that are formed in the comb-teeth shape with respect to the second fixed base portion, the second movable structure includes a second movable base portion and the plurality of second movable electrode pairs that are formed in the comb-teeth shape with respect to the second movable base portion, and the second movable base portion is linked directly to the second fixed base portion.

In the preferred embodiment of the present disclosure, the first fixed electrode includes a plurality of first fixed electrodes that are formed in a comb-teeth shape in plan view, the first movable electrode includes a plurality of first movable electrodes that are formed in a comb-teeth shape in plan view, the plurality of first movable electrodes are disposed such as to contactlessly mesh with the plurality of first fixed electrodes, the second fixed electrode includes a plurality of second fixed electrodes that are formed in a comb-teeth shape in plan view, the second movable electrode includes a plurality of second movable electrodes that are formed in a comb-teeth shape in plan view, and the plurality of second movable electrodes are disposed such as to contactlessly mesh with the plurality of second fixed electrodes.

In the preferred embodiment of the present disclosure, the first fixed structure includes a first fixed base portion that is supported by the first semiconductor substrate and the plurality of first fixed electrodes that are formed in the comb-teeth shape with respect to the first fixed base portion, the first movable structure includes a first movable base portion and the plurality of first movable electrodes that are formed in the comb-teeth shape with respect to the first movable base portion, the first movable base portion is supported by the first fixed base portion via the elastic structure, the second fixed structure includes a second fixed base portion that is supported by the second semiconductor substrate and the plurality of second fixed electrodes that are formed in the comb-teeth shape with respect to the second fixed base portion, the second movable structure includes a second movable base portion and the plurality of second movable electrodes that are formed in the comb-teeth shape with respect to the second movable base portion, and the second movable base portion is linked directly to the second fixed base portion.

In the preferred embodiment of the present disclosure, the acceleration detecting portion and the offset detecting portion each have a quadrilateral shape in plan view and the offset detecting portion is disposed obliquely outward with respect to the acceleration detecting portion.

In the preferred embodiment of the present disclosure, the acceleration detecting portion and the offset detecting portion each have a quadrilateral shape in plan view and the offset detecting portion is disposed to face the acceleration detecting portion.

In the following, preferred embodiments of the present disclosure shall be described in detail with reference to the accompanying drawings.

### [1] Overall Arrangement of Acceleration Sensor

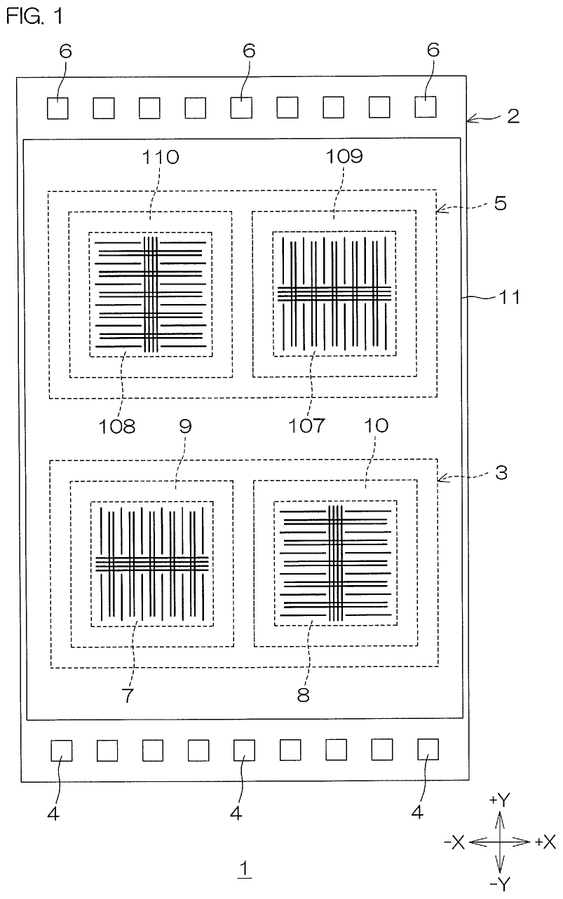

FIG. 1 is an illustrative plan view showing an acceleration sensor according to a first preferred embodiment of the present disclosure.

For convenience of description, a +X direction, a −X direction, a +Y direction, a −Y direction, a +Z direction, and a −Z direction shown in FIG. 1 to FIG. 10 are used at times in the following description. The +X direction is a predetermined direction along a front surface of a semiconductor substrate 2 in plan view and the +Y direction is a direction along the front surface of the semiconductor substrate 2 and is a direction that is orthogonal to the +X direction in plan view. The +Z direction is a direction along a thickness of the semiconductor substrate 2 and is a direction that is orthogonal to the +X direction and the +Y direction.

The −X direction is a direction opposite to the +X direction. The −Y direction is a direction opposite to the +Y direction. The −Z direction is a direction opposite to the +Z direction. The +X direction and the −X direction shall be referred to simply as the “X-axis direction” when referred to collectively. The +Y direction and the −Y direction shall be referred to simply as the “Y-axis direction” when referred to collectively. The +Z direction and the −Z direction shall be referred to simply as the “Z-axis direction” when referred to collectively.

An acceleration sensor 1 is an electrostatic capacitance type acceleration sensor. The acceleration sensor 1 has the semiconductor substrate 2. The semiconductor substrate 2 has, in plan view, a quadrilateral shape that is long in the Y-axis direction and has two sides parallel to the X-axis direction and two sides parallel to the Y-axis direction. The semiconductor substrate 2 is constituted of a conductive silicon substrate (for example, a low resistance substrate having a resistivity of 5Ω·m to 500Ω·m).

The acceleration sensor 1 includes an acceleration detecting portion (sensor portion) 3 that is disposed at a −Y side half portion of the semiconductor substrate 2 and a plurality of first electrode pads 4 that are disposed at the −Y side of the acceleration detecting portion 3 on the semiconductor substrate 2. Also, the acceleration sensor 1 includes an offset detecting portion 5 that is disposed at a +Y side half portion of the semiconductor substrate 2 and a plurality of second electrode pads 6 that are disposed at the −Y side of the offset detecting portion 5 of the semiconductor substrate 2.

The acceleration detecting portion 3 has an X-axis sensor 7, a Y-axis sensor 8, a first Z-axis sensor 9, and a second Z-axis sensor 10 as sensors that respectively detect accelerations acting in directions along three orthogonal axes in three-dimensional space. The X-axis sensor 7 is arranged to detect an acceleration acting in the X-axis direction. The Y-axis sensor 8 is arranged to detect an acceleration acting in the Y-axis direction. The first Z-axis sensor 9 and the second Z-axis sensor 10 are arranged to detect an acceleration acting in a Z-axis direction.

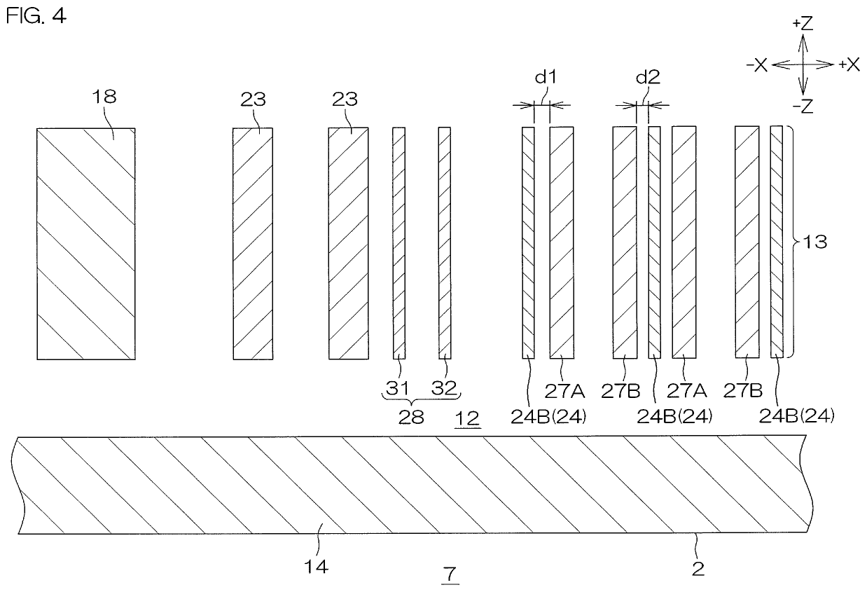

In the acceleration detecting portion 3, the semiconductor substrate 2 has a first cavity 12 (see FIG. 4) in its interior and the X-axis sensor 7, the Y-axis sensor 8, the first Z-axis sensor 9, and the second Z-axis sensor 10 are formed in an upper wall (surface layer portion) 13 of the semiconductor substrate 2 having a top surface that demarcates the first cavity 12 from a front surface side.

That is, the X-axis sensor 7, the Y-axis sensor 8, the first Z-axis sensor 9, and the second Z-axis sensor 10 are constituted of portions of the semiconductor substrate 2 and are supported in a state of floating with respect to a bottom wall 14 (see FIG. 4) of the semiconductor substrate 2 having a bottom surface that demarcates the first cavity 12 from a rear surface side.

The X-axis sensor 7 and the Y-axis sensor 8 are disposed adjacent to each other at an interval in the X-axis direction. The first Z-axis sensor 9 and the second Z-axis sensor 10 are disposed such as to surround the X-axis sensor 7 and the Y-axis sensor 8 respectively. In the first preferred embodiment, the Y-axis sensor 8 has substantially the same arrangement as the X-axis sensor 7 being rotated by 90° in plan view.

The first electrode pads 4 are connected to an external electronic component, are arranged to input signals into the respective sensors 7 to 10 or output signals from the respective sensors 7 to 10, and a necessary number thereof (nine in the example of FIG. 1) are provided. The external electronic component is, for example, an ASIC (application specific integrated circuit) element.

The offset detecting portion 5 has an X-axis offset detecting portion 107, a Y-axis offset detecting portion 108, a first Z-axis offset detecting portion 109, and a second Z-axis offset detecting portion 110. The X-axis offset detecting portion 107 is arranged to detect an offset amount with respect to the X-axis sensor 7 (hereinafter referred to as the “X-axis offset amount”). The Y-axis offset detecting portion 108 is arranged to detect an offset amount with respect to the Y-axis sensor 8 (hereinafter referred to as the “Y-axis offset amount”). The first Z-axis offset detecting portion 109 is arranged to detect an offset amount with respect to the first Z-axis sensor 9 (hereinafter referred to as the “first Z-axis offset amount”). The second Z-axis offset detecting portion 110 is arranged to detect an offset amount with respect to the second Z-axis sensor 10 (hereinafter referred to as the “second Z-axis offset amount”).

In the offset detecting portion 5, the semiconductor substrate 2 has, in its interior, a second cavity (not shown) similar to the first cavity 12 and the X-axis offset detecting portion 107, the Y-axis offset detecting portion 108, the first Z-axis offset detecting portion 109, and the second Z-axis offset detecting portion 110 are formed in an upper wall (surface layer portion) of the semiconductor substrate 2 having a top surface that demarcates the second cavity from a front surface side.

That is, the X-axis offset detecting portion 107, the Y-axis offset detecting portion 108, the first Z-axis offset detecting portion 109, and the second Z-axis offset detecting portion 110 are constituted of portions of the semiconductor substrate 2 and are supported in a state of floating with respect to a bottom wall of the semiconductor substrate 2 having a bottom surface that demarcates the second cavity from a rear surface side.

The X-axis offset detecting portion 107 and the Y-axis offset detecting portion 108 are disposed adjacent to each other at an interval in the X-axis direction. In this preferred embodiment, the X-axis offset detecting portion 107 is disposed such as to face the Y-axis sensor 8 in the Y-axis direction. Also, the Y-axis offset detecting portion 108 is disposed such as to face the X-axis sensor 7 in the Y-axis direction.

The first Z-axis offset detecting portion 109 is disposed such as to surround the X-axis offset detecting portion 107. The second Z-axis offset detecting portion 110 is disposed such as to surround the Y-axis offset detecting portion 108.

The second electrode pads 6 are connected to an external electronic component (for example, an ASIC element), are arranged to input signals into the respective offset detecting portions 107 to 110 or output signals from the respective offset detecting portions 107 to 110, and a necessary number thereof (nine in the example of FIG. 1) are provided.

A lid 11 constituted, for example, of a silicon substrate is coupled to the front surface of the semiconductor substrate 2 and thereby, the four sensors 7 to 10 and the four offset detecting portions 107 to 110 are covered and sealed by the lid 11.

### [2] X-Axis Sensor 7 and X-Axis Offset Detecting Portion 107

### [2.1] X-Axis Sensor 7

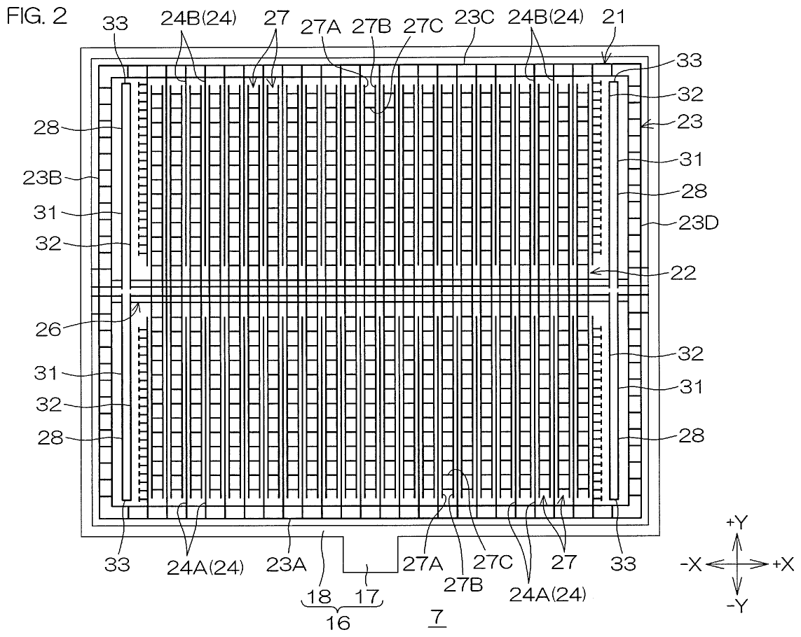

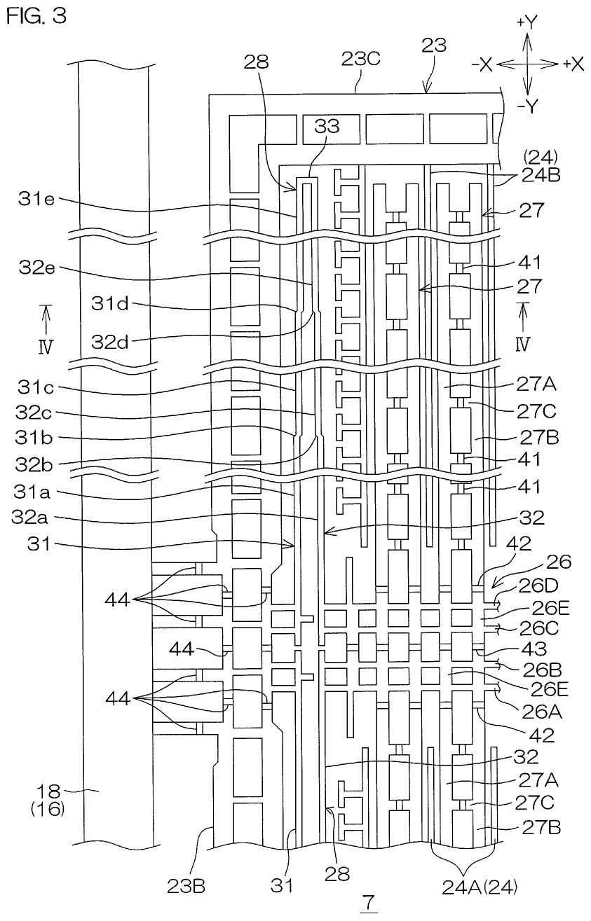

FIG. 2 is an illustrative plan view showing the X-axis sensor. FIG. 3 is an enlarged plan view of principal portions of FIG. 2. FIG. 4 is an enlarged illustrative sectional view taken along line IV-IV of FIG. 3.

A supporting portion 16 arranged to support the X-axis sensor 7 in the floating state is formed between the X-axis sensor 7 and the first Z-axis sensor 9. The supporting portion 16 integrally includes a supporting base portion 17 that extends toward the X-axis sensor 7 upon crossing the first Z-axis sensor 9 from an upper portion of one side wall (not shown) having a side surface that demarcates the first cavity 12 of the semiconductor substrate 2 from a lateral side and an annular portion 18 that surrounds the X-axis sensor 7. The supporting portion 16 is supported by the one side wall (not shown) of the semiconductor substrate 2 in the state of floating from the bottom wall 14 of the semiconductor substrate 2.

The supporting base portion 17 is of a quadrilateral shape that is long in the X-axis direction in plan view. The annular portion 18 is of a rectangular annular shape in plan view and includes a frame portion at the −Y side, a frame portion at the −X side, a frame portion at the +Y side, and a frame portion at the +X side. A length central portion of the frame portion at the −Y side of the annular portion 18 is linked to the supporting base portion 17. The X-axis sensor 7 is disposed at an inner side of the annular portion 18 and is supported at two sides at two locations of an inner side wall of the annular portion 18 that face each other.

The X-axis sensor 7 has a fixed structure 21 that is fixed to the supporting portion 16 provided inside the first cavity 12 and a movable structure 22 that is held such as to be capable of vibrating with respect to the fixed structure 21. The fixed structure 21 and the movable structure 22 are formed to be of the same thickness. The fixed structure 21 and the movable structure 22 are supported by the annular portion 18 in a state of floating from the bottom wall of the semiconductor substrate 2.

The fixed structure 21 includes a fixed base portion 23 and a plurality of fixed electrodes 24.

The fixed base portion 23 is of quadrilateral annular shape in plan view and disposed such as to surround a peripheral edge portion of an arrangement region of the X-axis sensor 7. The fixed base portion 23 includes a first frame portion 23A at the −Y side, a second frame portion 23B at the −X side, a third frame portion 23C at the +Y side, and a fourth frame portion 23D at the −X side. A length central portion of the second frame portion 23B and a length central portion of the fourth frame portion 23D are linked to the annular portion 18.

Each of the frame portions 23A to 23D of the fixed base portion 23 has a frame structure of ladder shape in plan view that includes a plurality (two in the example of FIG. 2) of main frames that extend in parallel to each other and a plurality of sub frames that are installed between the plurality of main frames.

The plurality of fixed electrodes 24 include a plurality of first fixed electrodes 24A that are formed in a comb-teeth shape on an inner side wall of the first frame portion 23A and a plurality of second fixed electrodes 24B that are formed in a comb-teeth shape on an inner side wall of the third frame portion 23C.

From the first frame portion 23A, the plurality of first fixed electrodes 24A extend in parallel to each other in the +Y direction at equal intervals in the X-axis direction. Tip portions of the first fixed electrodes 24A extend to a vicinity of a central portion in the Y-axis direction of the arrangement region of the X-axis sensor 7.

From the third frame portion 23C, the plurality of second fixed electrodes 24B extend in parallel to each other in the −Y direction at equal intervals in the X-axis direction. Tip portions of the second fixed electrodes 24B extend to a vicinity of the central portion in the Y-axis direction of the arrangement region of the X-axis sensor 7.

The movable structure 22 includes a movable base portion 26 and a plurality of movable electrode portions 27.

The movable base portion 26 extends in the X-axis direction at the central portion in the Y-axis direction of the arrangement region of the X-axis sensor 7 and both ends thereof are fixed to the fixed base portion 23 via spring portions 28 that are freely expandable/contractible in the X-axis direction. The spring portions 28 are an example of an “elastic structure” of the present disclosure.

The movable base portion 26 is constituted of a plurality (four in this preferred embodiment) of frames 26A to 26D that extend in parallel to the X-axis direction and both ends thereof are connected to the spring portions 28. Two spring portions 28 are provided at each of both ends of the movable base portion 26.

The plurality of movable electrode portions 27 are formed in a comb-teeth shape on each of both side walls of the movable base portion 26. The plurality of movable electrode portions 27 extend across the movable base portion 26 toward intervals between mutually adjacent first fixed electrodes 24A and intervals between mutually adjacent second fixed electrodes 24B.

That is, the movable electrode portions 27 of the comb-teeth shape that extend to the −Y side from the movable base portion 26 are disposed such as to mesh with the first fixed electrodes 24A of the comb-teeth shape without contacting the first fixed electrodes 24A. The movable electrode portions 27 of the comb-teeth shape that extend to the +Y side from the movable base portion 26 are disposed such as to mesh with the second fixed electrodes 24B of the comb-teeth shape without contacting the second fixed electrodes 24B.

Each movable electrode portion 27 includes a first movable electrode 27A and a second movable electrode 27B that extend in parallel to each other in the Y-axis direction at an interval in the X-axis direction and a plurality of linking portions 27C that link these. In this preferred embodiment, a portion of each first movable electrode 27A that crosses the movable base portion 26 and a portion of each second movable electrode 27B that crosses the movable base portion 26 function as reinforcing frames that reinforce the movable base portion 26 but do not function as the first movable electrode 27A and the second movable electrode 27B and therefore, these portions shall be referred to as reinforcing frames 26E (see FIG. 3). In the following, it shall be deemed that the reinforcing frames 26E do not constitute the first movable electrodes 27A or the second movable electrodes 27B.

In the movable electrode portions 27, the first movable electrodes 27A are disposed at the −X side with respect to the second movable electrodes 27B. In a state where an acceleration in the X-axis direction is not acting, an interval between a first movable electrode 27A and the first fixed electrode 24A (or second fixed electrode 24B) adjacent thereto is equal to an interval between a second movable electrode 27B and the first fixed electrode 24A (or second fixed electrode 24B) adjacent thereto. The first movable electrode 27A and the second movable electrode 27B included in each movable electrode portion 27 are an example of a “movable electrode pair” of the present disclosure.

Referring to FIG. 3, a length intermediate portion of each linking portion 27C is constituted of a first isolation coupling portion (insulating layer) 41 that is constituted of silicon oxide. A portion close to the movable base portion 26 of each of the movable electrodes 27A and 27B that extend to the −Y-side from the movable base portion 26 and a portion close to the movable base portion 26 of each of the movable electrodes 27A and 27B that extend to the +Y-side from the movable base portion 26 are each constituted of a second isolation coupling portion 42 that is constituted of silicon oxide.

Further, length intermediate portions of frames (including the reinforcing frames 26E and other frames) that link the two frames 26A and 26B at the −Y side with the two frames 26C and 26D at the +Y side among the four frames 26A to 26D constituting the movable base portion 26 are each constituted of a third isolation coupling portion 43 that is constituted of silicon oxide.

Therefore, each first movable electrode 27A is electrically insulated from other first movable electrodes 27A, the second movable electrodes 27B, and the movable base portion 26. Also, each second movable electrode 27B is electrically insulated from other second movable electrodes 27B, the first movable electrodes 27A, and the movable base portion 26. Further, the two frames 26A and 26B at the −Y side are electrically insulated from the two frames 26C and 26D at the +Y side in the movable base portion 26.

Next, the spring portions 28 shall be described. At times in the following, the spring portion 28 disposed at the +Y side of the −X side is referred to as the “first spring portion 28,” the spring portion 28 disposed at the −Y side of the −X side is referred to as the “second spring portion 28,” the spring portion 28 disposed at the +Y side of the +X side is referred to as the “third spring portion 28,” and the spring portion 28 disposed at the −Y side of the +X side is referred to as the “fourth spring portion 28,” respectively.

Referring to FIG. 2 and FIG. 3, the first spring portion 28 has, in plan view, a vertically-long U shape that opens downward. Specifically, the spring portion 28 includes, in plan view, a first frame 31 that extends in the Y-axis direction, a second frame 32 that is disposed at an interval to the +X side from the first frame 31 and extends substantially in parallel to the first frame 31, and a linking frame 33 that links end portions at the +Y direction side of the first frame 31 and the second frame 32 to each other.

The first frame 31 and the second frame 32 include first rectilinear portions 31a and 32a that are parallel to each other, second rectilinear portions 31c and 32c that are parallel to each other and connected via first connection portions 31b and 32b to +Y side ends of the first rectilinear portions 31a and 32a, and third rectilinear portions 31e and 32e that are parallel to each other and connected via second connection portions 31d and 32d to +Y side ends of the second rectilinear portions 31c and 32c.

From the +Y side ends of the first rectilinear portions 31a and 32a, the first connection portions 31b and 32b extend such that an interval therebetween narrows gradually in the +Y direction. An interval between the second rectilinear portions 31c and 32c is narrower than an interval between the first rectilinear portions 31a and 32a.

From the +Y side ends of the second rectilinear portions 31c and 32c, the second connection portions 31d and 32d extend such that an interval therebetween narrows gradually in the +Y direction. An interval between the third rectilinear portions 31e and 32e is narrower than the interval between the second rectilinear portions 31c and 32c. +Y side ends of the third rectilinear portions 31e and 32e are linked to each other by the linking frame 33.

A −Y side end portion of the first rectilinear portion 31a of the first frame 31 (a −Y side end portion of the first frame 31) is mechanically connected to the fixed base portion 23. In FIG. 3, the reference sign 44 indicates a fourth isolation coupling portion that is constituted of a silicon oxide film. A −Y side end portion of the first rectilinear portion 32a of the second frame 32 (a −Y side end portion of the second frame 32) is mechanically and electrically connected to the two frames 26C and 26D at the +Y side of the movable base portion 26.

The second spring portion 28 has a planar shape that is line symmetrical to the first spring portion 28 in relation to a straight line passing through a center between the first spring portion 28 and the second spring portion 28 and extending in the X-axis direction. In the second spring portion 28, a +Y side end of the first frame 31 is mechanically connected to the fixed base portion 23. Also, a +Y side end portion of the second frame 32 is mechanically and electrically connected to the two frames 26A and 26B at the −Y side of the movable base portion 26.

The third spring portion 28 has a planar shape that is line symmetrical to the first spring portion 28 in relation to a straight line passing through a center between the first spring portion 28 and the third spring portion 28 and extending in the Y-axis direction. Therefore, in the third spring portion 28, the second frame 32 is disposed at the −X side with respect to the first frame 31.

In the third spring portion 28, a −Y side end of the first frame 31 is mechanically connected to the fixed base portion 23. Also, a −Y side end portion of the second frame 32 is mechanically and electrically connected to the two frames 26C and 26D at the +Y side of the movable base portion 26.

The fourth spring portion 28 has a planar shape that is line symmetrical to the third spring portion 28 in relation to a straight line passing through a center between the third spring portion 28 and the fourth spring portion 28 and extending in the X-axis direction. Therefore, in the fourth spring portion 28, the second frame 32 is disposed at the −X side with respect to the first frame 31. In the fourth spring portion 28, a +Y side end of the first frame 31 is mechanically connected to the fixed base portion 23. Also, a +Y side end portion of the second frame 32 is mechanically and electrically connected to the two frames 26A and 26B at the −Y side of the movable base portion 26.

The four spring portions 28 function as springs that support the movable base portion 26 such as to be movable in the X-axis direction and also function as conductive paths.

An unillustrated insulating film is formed on the front surface of the semiconductor substrate 2 including the fixed structure 21 and the movable structure 22. Unillustrated wirings are formed on a front surface of the insulating film. The wirings include a first wiring arranged to electrically connect the plurality of first fixed electrodes 24A and the plurality of second fixed electrodes 24B to a first electrode pad 4 for the fixed electrodes, a second wiring arranged to electrically connect the plurality of first movable electrodes 27A to a first electrode pad 4 for the first movable electrodes, and a third wiring arranged to electrically connect the second movable electrodes 27B to a first electrode pad 4 for the second movable electrodes.

The second wiring includes a wiring arranged to electrically connect the respective first movable electrodes 27A to the two frames 26C, 26D at the +Y side of the movable base portion 26 and a wiring arranged to electrically connect the first frames 31 of the first spring portion 28 and the third spring portion 28 to the first electrode pad 4 for the first movable electrodes.

The third wiring includes a wiring arranged to electrically connect the respective second movable electrodes 27B to the two frames 26A, 26B at the −Y side of the movable base portion 26 and a wiring arranged to electrically connect the first frames 31 of the second spring portion 28 and the fourth spring portion 28 to the first electrode pad 4 for the second movable electrodes.

In this preferred embodiment, a length of the X-axis sensor 7 in each of the X-axis direction and the Y-axis direction is, for example, approximately 300 μm. A Z-axis direction length from a +Z side surface of the X-axis sensor 7 to an inner surface (+Z side surface) of the bottom wall 14 (see FIG. 4) of the semiconductor substrate 2 is, for example, approximately 50 μm. A Z-axis direction length from the +Z side surface of the X-axis sensor 7 to an outer surface (−Z side surface) of the bottom wall 14 of the semiconductor substrate 2 is, for example, approximately 200 μm to 300 μm. Also, a length in the Z-axis direction of each of the fixed electrodes 24, the first movable electrodes 27A, and the second movable electrodes 27B is, for example, approximately 15 μm to 30 μm.

With the X-axis sensor 7, when an acceleration in the X-axis direction acts, the movable base portion 26 supported by the four spring portions 28 vibrates in the X-axis direction. Thereby, each of the first movable electrodes 27A and the second movable electrodes 27B extending from movable base portion 26 also vibrates in the X-axis direction between two mutually adjacent first fixed electrodes 24A or between two mutually adjacent second fixed electrodes 24B. When the movable base portion 26 moves in the +X direction, each first movable electrode 27A moves to a position away from the adjacent fixed electrode 24 and each second movable electrode 27B moves to a position approaching the adjacent fixed electrode 24. Oppositely, when the movable base portion 26 moves in the −X direction, each first movable electrode 27A moves to a position approaching the adjacent fixed electrode 24 and each second movable electrode 27B moves to a position away from the adjacent fixed electrode 24.

Thereby, a facing distance d1 between the first movable electrode 27A and the fixed electrode 24 adjacent thereto and a facing distance d2 between the second movable electrode 27B and the fixed electrode 24 adjacent thereto change. Then, by detecting a change in an electrostatic capacitance C1 between the first movable electrode 27A and the fixed electrode 24 due to the change in the facing distance d1 and a change in an electrostatic capacitance C2 between the second movable electrode 27B and the fixed electrode 24 due to the change in the facing distance d2, the acceleration in the X-axis direction is detected.

### [2.2] X-Axis Offset Detecting Portion 107

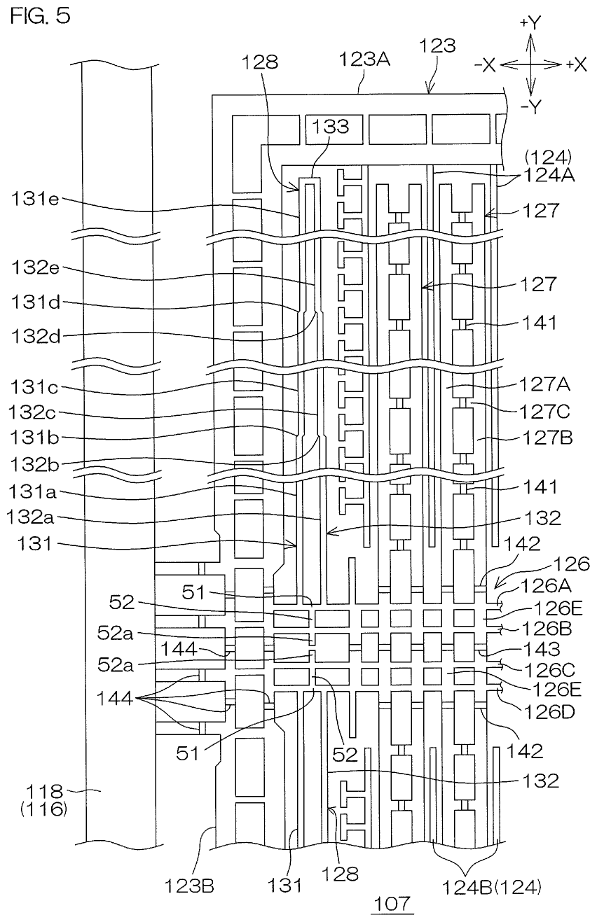

FIG. 5 is an enlarged plan view of principal portions of the X-axis offset detecting portion.

In FIG. 5, respective portions corresponding to those in FIG. 3 described above are indicated by attaching reference signs with which 100 is added to the reference signs in FIG. 3.

In this preferred embodiment, if it is supposed that the X-axis offset detecting portion 107 is disposed to face the +Y side of the X-axis sensor 7, the X-axis offset detecting portion 107 has a planar shape that is substantially similar to a planar shape that is line symmetrical to the X-axis sensor 7 in relation to a straight line passing through a center between the X-axis sensor 7 and the X-axis offset detecting portion 107 and extending in the X-axis direction.

Therefore, the fixed electrodes 24B disposed at the +Y side of the movable base portion 26 in FIG. 3 correspond to fixed electrodes 124 (124B) disposed at the −Y side of a movable base portion 126 in FIG. 5. Similarly, the fixed electrodes 24A disposed at the −Y side of the movable base portion 26 in FIG. 3 correspond to fixed electrodes 124 (124A) disposed at the +Y side of the movable base portion 126 in FIG. 5. Similarly, the frame portion 23A at the −Y side of the fixed base portion 23 in FIG. 3 corresponds to a frame portion 123A at the +Y side of a fixed base portion 123 in FIG. 5.

Also, the frame 26A at the most −Y side in FIG. 3 corresponds to a frame 126A at the most +Y side in FIG. 5 and the frame 26B at the second to the most −Y side in FIG. 3 corresponds to a frame 126B at the second to the most +Y side in FIG. 5. Also, the frame 26C at the third to the most −Y side in FIG. 3 corresponds to the frame 126C at the third to the most +Y side in FIG. 5 and the frame 26D at the most +Y side in FIG. 3 corresponds to a frame 126D at the most −Y in FIG. 5.

The X-axis offset detecting portion 107 has a disabling structure that disables a function of movable electrodes 127A and 127B displacing with respect to the fixed electrodes 124.

−X side ends of the four frames 126A to 126D in the movable base portion 126 are elongated toward the −X side in comparison to the four frames 26A to 26D of the X-axis sensor 7 and are linked to a second frame portion 123B of the fixed base portion 123. +X side ends of the four frames 126A to 126D in the movable base portion 126 are elongated toward the +X side in comparison to the four frames 26A to 26D of the X-axis sensor 7 and are linked to a fourth frame portion of the fixed base portion 123.

That is, with the X-axis offset detecting portion 107, both ends of the movable base portion 126 are linked directly to the fixed base portion 123. The structure in which both ends of the movable base portion 126 are linked directly to the fixed base portion 123 is an example of an “disabling structure” of the present disclosure.

As with the first spring portion 28 of the X-axis sensor 7, a first spring 128 disposed at the +Y side of the −X side includes a first frame 131, a second frame 132, and a linking frame 133. The first frame 131 and the second frame 132 include first rectilinear portions 131a and 132a, first connection portions 131b and 132b, second rectilinear portions 131c and 132c, second connection portions 131d and 132d, and third rectilinear portions 131e and 132e.

A −Y side end portion of the first frame 131 (a −Y side end portion of the first rectilinear portion 131a) and a −Y side end portion of the second frame 132 (a −Y side end portion of the second rectilinear portion 132a) are mechanically and electrically connected to the frame 126A at the most +Y side among the four frames 126A to 126D. Therefore, both ends of the first spring portion 128 are linked to each other by a portion (hereinafter referred to as the “coupling portion 51”) between a connection point with the first frame 131 and a connection point with the second frame 132 of the frame 126A. A spring function of the first spring portion 128 is thereby disabled.

The frame 126B that is second from the +Y side among the four frames 126A to 126D and the coupling portion 51 are linked by a linking frame 52 that extends in the Y-axis direction. A −Y side end portion of the linking frame 52 has a projecting portion 52a that projects to the −Y side from the frame 126B that is second from the +Y side.

A second spring portion 128 disposed at the −Y side of the −X side and a connection structure at both ends thereof have planar shapes that are line symmetrical to the first spring portion 128 and the connection structure at both ends thereof in relation to a straight line passing through a center between the first spring portion 128 and the second spring portion 128 and extending in the X-axis direction. A +Y side end portion of the first frame 131 and a +Y side end portion of the second frame 132 of the second spring portion 128 are mechanically and electrically connected to the frame 126D at the most −Y side among the four frames 126A to 126D.

Therefore, both ends of the second spring portion 28 are linked to each other by a portion (hereinafter referred to as the “coupling portion 51”) between a connection point with the first frame 131 of the frame 126D and a connection point with the second frame 132 of the frame 126D. A spring function of the second spring portion 28 is thereby disabled.

The frame 126C that is second from the −Y side among the four frames 126A to 126D and the coupling portion 51 are linked by the linking frame 52 that extends in the Y-axis direction. A +Y side end portion of the linking frame 52 has the projecting portion 52a that projects to the +Y side from the frame 126C that is second from the −Y side.

A third spring portion 128 disposed at the +Y side of the +X side and a connection structure at both ends thereof have planar shapes that are line symmetrical to the first spring portion 128 and the connection structure at both ends thereof in relation to a straight line passing through a center between the first spring portion 128 and the third spring portion 128 and extending in the Y-axis direction and therefore detailed description thereof shall be omitted.

A fourth spring portion 128 disposed at the −Y side of the +X side and a connection structure at both ends thereof have planar shapes that are line symmetrical to the second spring portion 128 and the connection structure at both ends thereof in relation to a straight line passing through a center between the second spring portion 128 and the fourth spring portion 128 and extending in the Y-axis direction and therefore detailed description thereof shall be omitted.

An unillustrated insulating film is formed on the front surface of the semiconductor substrate 2 including the fixed structure 121 and the movable structure 122. Unillustrated wirings are formed on a front surface of the insulating film. The wirings include a fourth wiring arranged to electrically connect the plurality of first fixed electrodes 124A and the plurality of second fixed electrodes 124B to a second electrode pad 6 for the fixed electrodes, a fifth wiring arranged to electrically connect the plurality of first movable electrodes 127A to a second electrode pad 6 for the first movable electrodes, and a sixth wiring arranged to electrically connect the plurality of second movable electrodes 127B to a second electrode pad 6 for the second movable electrodes.

With the X-axis offset detecting portion 107, both ends of the movable base portion 126 are linked directly to the fixed base portion 123. In other words, the spring functions of the four spring portions 128 are disabled. The function of the movable electrodes 127A and 127B displacing with respect to the fixed electrodes 124A and 124B is thereby disabled. The movable electrodes 127A and 127B therefore do not displace with respect to the fixed electrodes 124A and 124B even when an acceleration in the X-axis direction acts.

However, the movable electrodes 127A and 127B undergo displacements in three-dimensional directions with respect to the fixed electrodes 124A and 124B due to a stress (package stress) based on a temperature change. An acceleration in accordance with a displacement in the X-axis direction among the displacements in three-dimensional directions is detected by the X-axis offset detecting portion 107. An X-axis offset amount for eliminating a temperature-change-based error from the output of the X-axis sensor 7 is thereby detected.

### [3] Y-Axis Sensor 8 and Y-Axis Offset Detecting Portion 108

Since the Y-axis sensor 8 has substantially the same arrangement as the X-axis sensor 7 being rotated by 90° in plan view, detailed description thereof shall be omitted. With the Y-axis sensor 8, each of the fixed electrodes 24 (24A and 24B) and the movable electrodes 27A and 27B extends in the X-axis direction and when an acceleration in the Y-axis direction acts, the movable base portion 26 vibrates in the Y-axis direction. Thereby, each of the first movable electrodes 27A and the second movable electrodes 27B also vibrates in the Y-axis direction between two mutually adjacent fixed electrodes 24. Therefore, by electrically detecting changes in an electrostatic capacitance of a capacitor constituted of the first movable electrode 27A and the adjacent fixed electrode 24 and an electrostatic capacitance of a capacitor constituted of the second movable electrode 27B and the adjacent fixed electrode 24, the acceleration acting in the Y-axis direction can be detected.

Since the Y-axis offset detecting portion 108 has substantially the same arrangement as the X-axis offset detecting portion 107 being rotated by 90° in plan view, detailed description thereof shall be omitted. With the Y-axis offset detecting portion 108, each of the fixed electrodes 124 (124A and 124B), the first movable electrodes 127A, and the second movable electrodes 127B extends in the X-axis direction. However, as with the X-axis offset detecting portion 107, the function of the first movable electrodes 127A and the second movable electrodes 127B displacing with respect to the fixed electrodes 124 is disabled. The Y-axis offset detecting portion 108 can thereby detect a Y-axis offset amount for eliminating a temperature-change-based error from the output of the Y-axis sensor 8.

### [4] First Z-Axis Sensor 9 and Second Z-Axis Sensor 10

### [4.1] First Z-Axis Sensor 9

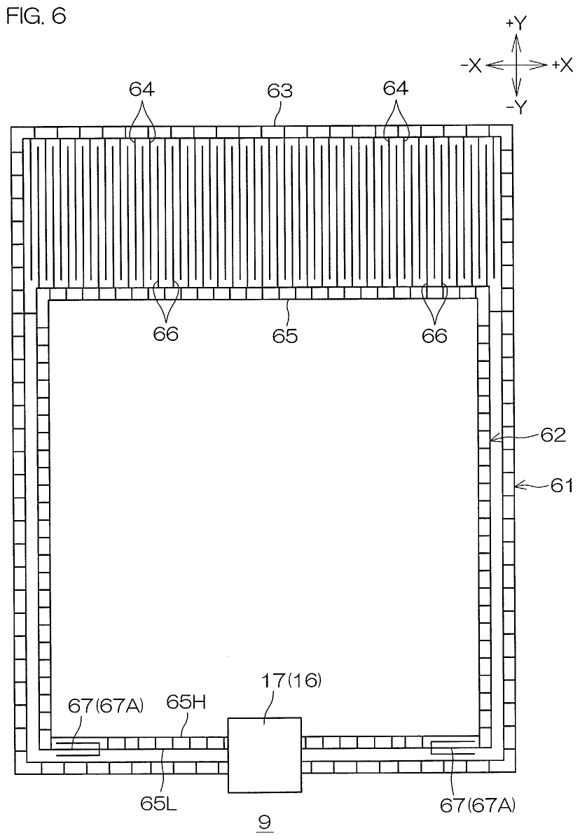

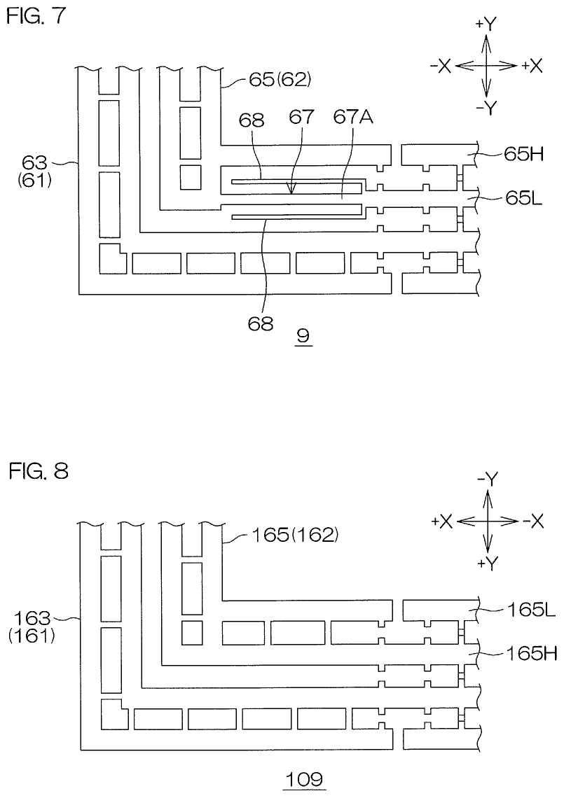

An arrangement of the first Z-axis sensor 9 shall now be described with reference to FIG. 1, FIG. 6, and FIG. 7.

FIG. 6 is an illustrative plan view showing the first Z-axis sensor. FIG. 7 is an enlarged plan view of principal portions of FIG. 6.

As mentioned above, the semiconductor substrate 2 has the cavity 12 (see FIG. 4) in its interior. At a front surface portion of the semiconductor substrate 2, the first Z-axis sensor 9 and the second Z-axis sensor 10 that are supported by the supporting portion 16 in a state of floating with respect to the bottom wall 14 (see FIG. 4) of the semiconductor substrate 2 are disposed such as to surround the X-axis sensor 7 and the Y-axis sensor 8, respectively.

The first Z-axis sensor 9 has a fixed structure 61 that is fixed to the supporting portion 16 (supporting base portion 17) provided inside the cavity 12 and a movable structure 62 that is held such as to be capable of vibrating with respect to the fixed structure 61. The fixed structure 61 and the movable structure 62 are formed to be of the same thickness.

With the first Z-axis sensor 9 shown in FIG. 6, the movable structure 62 is disposed such as to surround the X-axis sensor 7 (more specifically, the annular portion 18 of the supporting portion 16 described above) and the fixed structure 61 is disposed such as to further surround the movable structure 62. The fixed structure 61 and the movable structure 62 are connected integrally to a side wall at the −X side and a side wall at the +X side of the supporting base portion 17.

The fixed structure 61 includes a fixed base portion 63 of quadrilateral annular shape in plan view that is fixed to the supporting base portion 17. The fixed base portion 63 includes a frame portion at the −Y side, a frame portion at the −X side, a frame portion at the +Y side, and a frame portion at the +X side. The fixed structure 61 further includes a plurality of fixed electrodes 64 that are provided at the +Y side frame portion of the fixed base portion 63.

Each frame portion of the fixed base portion 63 has a frame structure of ladder shape in plan view that includes a plurality (two in the present example) of main frames of rectilinear shape that extend in parallel to each other and a plurality of sub frames that are installed between the plurality of main frames.

The plurality of fixed electrodes 64 are formed in a comb-teeth shape on an inner side wall of the +Y side frame portion of the fixed base portion 63. The fixed electrodes 64 of the comb-teeth shape extend in parallel to each other in the −Y direction at equal intervals in the X-axis direction respectively from the +Y side frame portion of the fixed base portion 63.

The movable structure 62 includes a movable base portion 65 of quadrilateral annular shape in plan view. The movable base portion 65 includes a frame portion at the −Y side, a frame portion at the −X side, a frame portion at the +Y side, and a frame portion at the +X side. The movable structure 62 further includes a plurality of movable electrodes 66 that are provided at the +Y side frame portion of the movable base portion 65.

The plurality of movable electrodes 66 are formed in a comb-teeth shape on an outer side wall of the +Y side frame portion of the movable base portion 65. The plurality of movable electrodes 66 extend from the +Y side frame portion of the movable base portion 65 toward intervals between mutually adjacent fixed electrodes 64. That is, the plurality of movable electrodes 66 extend in the Y-axis direction. The movable electrodes 66 of the comb-teeth shape are disposed such as to mesh with the fixed electrodes 64 of the comb-teeth shape without contacting the fixed electrodes 64.

Each frame portion of the movable base portion 65 has a frame structure of ladder shape in plan view that includes a plurality (two in the present example) of main frames of rectilinear shape that extend in parallel to each other and a plurality of sub frames that are installed between the plurality of main frames.

The −Y side frame portion of the movable base portion 65 is interrupted at a central portion. That is, the −Y side frame portion of the movable base portion 65 includes a −X side portion and a +X side portion. A +X direction end of the −X side portion of the −Y side frame portion of the movable base portion 65 is linked to the supporting portion 16. A −X direction end of the +X side portion of the −Y side frame portion of the movable base portion 65 is linked to the supporting portion 16. The −Y side frame portion of the movable base portion 65 can thus also be regarded as being a portion of the fixed base portion 63.

A −X side end portion of the −X side portion of the −Y side frame portion of the movable base portion 65 and a −Y side end portion of the −X side frame portion of the movable base portion 65 are linked via a spring portion 67 at the −X side. Similarly, a +X side end portion of the +X side portion of the −Y side frame portion of the movable base portion 65 and a −Y side end portion of the +X side frame portion of the movable base portion 65 are linked via a spring portion 67 at the +X side. The spring portions 67 are an example of the “elastic structure” of the present disclosure.

Of the two main frames of the −Y side frame portion of the movable base portion 65, the main frame at the −Y side shall be represented by 65L and the main frame at the +Y side shall be represented by 65H.

As shown in FIG. 6 and FIG. 7, the spring portion 67 at the −X side is constituted of a single rectilinear frame 67A that extends in the −X direction from a −X direction end of the main frame 65L and is narrower in width than the main frame 65L. A −X side end of the rectilinear frame 67A is linked to the −Y side end portion of the −X side frame portion of the movable base portion 65.

On the main frame 65L are formed a gap adjusting frame 68 of L shape that extends in the −Y direction from the −X side end of the main frame 65L and thereafter extends in the −X direction in parallel to the rectilinear frame 67A and a gap adjusting frame 68 of L shape that extends in the +Y direction from the −X side end of the main frame 65L and thereafter extends in the −X direction in parallel to the rectilinear frame 67A. The gap adjusting frames 68 are provided to adjust gaps (intervals) between frames such that the gaps between frames do not become too wide.

The spring portion 67 at the +X side has a planar shape that is line symmetrical to the spring portion 67 at the −X side in relation to a straight line passing through a center between the spring portion 67 at the −X side and the spring portion 67 at the +X side and extending in the Y-axis direction. Therefore, the spring portion 67 at the +X side is constituted of a single rectilinear frame 67A that extends in the +X direction from a +X direction end of the main frame 65L. A +X side end of the rectilinear frame 67A is linked to the −Y side end portion of the +X side frame portion of the movable base portion 65.

On the main frame 65L are formed a gap adjusting frame 68 of L shape that extends in the −Y direction from the +X side end of the main frame 65L and thereafter extends in the +X direction in parallel to the rectilinear frame 67A and a gap adjusting frame 68 of L shape that extends in the +Y direction from the +X side end of the main frame 65L and thereafter extends in the +X direction in parallel to the rectilinear frame 67A.

The two spring portions 67 function as springs for making the movable electrodes 66 movable in the Z-axis direction. That is, with the first Z-axis sensor 9, the spring portions 67 distort elastically and by the movable base portion 65 vibrating as it were a pendulum in a direction of approaching and a direction of separating away from the bottom wall 14 (see FIG. 4) of the semiconductor substrate 2 with the spring portions 67 as support points, the movable electrodes 66 that are meshed in comb-teeth shape with the fixed electrodes 64 vibrate in the Z-axis direction.

When an acceleration in the Z-axis direction acts on the first Z-axis sensor 9, the movable electrodes 66 vibrate in the Z-axis direction. Thereby, an area of regions in which facing surfaces of the movable electrodes 66 and the fixed electrodes 64 overlap changes. By electrically detecting a change in electrostatic capacitance due to the change in the area, the acceleration acting in the Z-axis direction can be detected.

### [4.2] Second Z-Axis Sensor 10

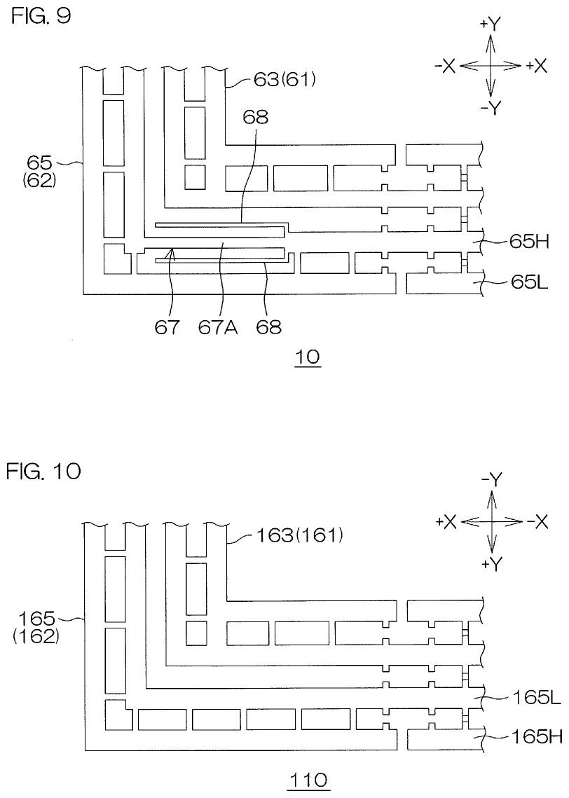

FIG. 9 is an enlarged plan view of principal portions of the second Z-axis sensor 10.

With the second Z-axis sensor 10, the fixed structure 61 is disposed such as to surround the Y-axis sensor 8 and the movable structure 62 is disposed such as to further surround the fixed structure 61. Therefore, with the second Z-axis sensor 10, the movable electrodes 66 of the first Z-axis sensor 9 shown in FIG. 6 become the fixed electrodes 64 and the fixed electrodes 64 of the first Z-axis sensor 9 shown in FIG. 6 become the movable electrodes 66.

The −Y side frame portion of the movable base portion 65 is interrupted at a central portion. That is, the −Y side frame portion of the movable base portion 65 includes a −X side portion and a +X side portion. A +X direction end of the −X side portion of the −Y side frame portion of the movable base portion 65 is linked to the supporting portion 16 (see FIG. 6). A −X direction end of the +X side portion of the −Y side frame portion of the movable base portion 65 is linked to the supporting portion 16. The −Y side frame portion of the movable base portion 65 can thus also be regarded as being a portion of the fixed base portion 63.

A −X side end portion of the −X side portion of the −Y side frame portion of the movable base portion 65 and a −Y side end portion of the −X side frame portion of the movable base portion 65 are linked via a spring portion 67 at the −X side. Similarly, a +X side end portion of the +X side portion of the −Y side frame portion of the movable base portion 65 and a −Y side end portion of the +X side frame portion of the movable base portion 65 are linked via a spring portion 67 at the +X side. The spring portions 67 are an example of the “elastic structure” of the present disclosure.

Of the two main frames of the −Y side frame portion of the movable base portion 65, the main frame at the −Y side shall be represented by 65L and the main frame at the +Y side shall be represented by 65H.

As shown in FIG. 9, the spring portion 67 at the −X side is constituted of a single rectilinear frame 67A that extends in the −X direction from a −X direction end of the main frame 65H and is narrower in width than the main frame 65H. A −X side end of the rectilinear frame 67A is linked to the −Y side end portion of the −X side frame portion of the movable base portion 65.

On the main frame 65H are formed a gap adjusting frame 68 of L shape that extends in the −Y direction from the −X side end of the main frame 65H and thereafter extends in the −X direction in parallel to the rectilinear frame 67A and a gap adjusting frame 68 of L shape that extends in the +Y direction from the −X side end of the main frame 65H and thereafter extends in the −X direction in parallel to the rectilinear frame 67A. The gap adjusting frames 68 are provided to adjust gaps (intervals) between frames such that the gaps between frames do not become too wide.

The spring portion 67 at the +X side has a planar shape that is line symmetrical to the spring portion 67 at the −X side in relation to a straight line passing through a center between the spring portion 67 at the −X side and the spring portion 67 at the +X side and extending in the Y-axis direction. Therefore, the spring portion 67 at the +X side is constituted of a single rectilinear frame 67A that extends in the +X direction from a +X direction end of the main frame 65H. A +X side end of the rectilinear frame 67A is linked to the −Y side end portion of the +X side frame portion of the movable base portion 65.

The two spring portions 67 function as springs for making the movable electrodes 66 movable in the Z-axis direction. That is, with the second Z-axis sensor 10, the spring portions 67 distort elastically and by the movable base portion 65 vibrating as it were a pendulum in a direction of approaching and a direction of separating away from the bottom wall 14 (see FIG. 4) of the semiconductor substrate 2 with the spring portions 67 as support points, the movable electrodes 66 that are meshed in comb-teeth shape with the fixed electrodes 64 vibrate in the Z-axis direction.

When an acceleration in the Z-axis direction acts on the second Z-axis sensor 10, the movable electrodes 66 vibrate in the Z-axis direction. Thereby, an area of regions in which facing surfaces of the movable electrodes 66 and the fixed electrodes 64 overlap changes. By electrically detecting a change in electrostatic capacitance due to the change in the area, the acceleration acting in the Z-axis direction can be detected.

### [4.3] Positional Relationships in the Z-Axis Direction of the Fixed Electrodes 64 and the Movable Electrodes 66

In this preferred embodiment, with the first Z-axis sensor 9, the fixed electrode 64 side (+Y end portion side) of the fixed structure 61 that is disposed at the outer side of the movable structure 62 is warped such as to sag toward the −Z side due to influence of an unillustrated silicon oxide film formed on a front surface of the fixed base portion 63.

On the other hand, with the second Z-axis sensor 10, the movable electrode 66 side (+Y end portion side) of the movable structure 62 that is disposed at the outer side of the fixed structure 61 is warped such as to sag toward the −Z side due to influence of an unillustrated silicon oxide film formed on a front surface of a movable base portion.

FIG. 11 is a schematic view showing positional relationships in the Z-axis direction of the fixed electrodes and the movable electrodes of the Z-axis sensors when an acceleration in the Z-axis direction is not acting and positional relationships in the Z-axis direction of the fixed electrodes and the movable electrodes of the Z-axis sensors when an acceleration in the Z-axis direction acts. In FIG. 11, a fixed electrode is represented by F and a movable electrode is represented by M.

At the upper left of FIG. 11, the positional relationship in the Z-axis direction of the fixed electrodes F and the movable electrodes M in the first Z-axis sensor 9 when an acceleration in the Z-axis direction is not acting on the acceleration sensor 1 is shown.

At the upper right of FIG. 11, the positional relationship in the Z-axis direction of the fixed electrodes F and the movable electrodes M in the second Z-axis sensor 10 when an acceleration in the Z-axis direction is not acting on the acceleration sensor 1 is shown.

At the lower left of FIG. 11, the positional relationship in the Z-axis direction of the fixed electrodes F and the movable electrodes M of the first Z-axis sensor 9 when an acceleration in the +Z direction acts on the acceleration sensor 1 is shown.

At the lower right of FIG. 11, the positional relationship in the Z-axis direction of the fixed electrodes F and the movable electrodes M of the second Z-axis sensor 10 when the acceleration in the +Z direction acts on the acceleration sensor 1 is shown.

When the acceleration in the +Z direction is not acting on the acceleration sensor 1, the fixed electrodes F are disposed at positions shifted to the −Z side with respect to the movable electrodes M in the first Z-axis sensor 9. On the other hand, in the second Z-axis sensor 10, the movable electrodes M are disposed at positions shifted to the −Z side with respect to the fixed electrodes F.

When the acceleration in the +Z direction acts on the acceleration sensor 1, the movable electrodes M move in the −Z direction with respect to the fixed electrodes F as shown in FIG. 11. Thereby, in the first Z-axis sensor 9, an electrostatic capacitance C1 between the fixed electrodes F and the movable electrodes M increases and in the second Z-axis sensor 10, an electrostatic capacitance C2 between the fixed electrodes F and the movable electrodes M decreases.

On the other hand, when an acceleration in the −Z direction acts on the acceleration sensor 1, the movable electrodes M move in the +Z direction with respect to the fixed electrodes F. Thereby, in the first Z-axis sensor 9, the electrostatic capacitance C1 between the fixed electrodes F and the movable electrodes M decreases and in the second Z-axis sensor 10, the electrostatic capacitance C2 between the fixed electrodes F and the movable electrodes M increases.

By detecting the change in the electrostatic capacitance C1 between the fixed electrodes F and the movable electrodes M in the first Z-axis sensor 9 and the change in the electrostatic capacitance C2 between the fixed electrodes F and the movable electrodes M in the second Z-axis sensor 10, the acceleration in the Z-axis direction is detected.

### [5] First Z-Axis Offset Detecting Portion 109 and Second Z-Axis Offset Detecting Portion 110

### [5.1] First Z-Axis Offset Detecting Portion 109

FIG. 8 is an enlarged plan view of principal portions of the first Z-axis offset detecting portion.

In FIG. 8, respective portions corresponding to those in FIG. 7 described above are indicated by attaching reference signs with which 100 is added to the reference signs in FIG. 7.

The first Z-axis offset detecting portion 109 has substantially the same arrangement as the first Z-axis sensor 9 being rotated by 1800 in plan view. However, the first Z-axis offset detecting portion 109 has a disabling structure that disables a function of movable electrodes (not shown) displacing with respect to fixed electrodes (not shown).

In the first Z-axis offset detecting portion 109, a plurality of the fixed electrodes (not shown) are formed on an inner side wall of a −Y side frame portion of a fixed base 163 and a plurality of the movable electrodes (not shown) are formed on an outer side wall of a −Y side frame portion of a movable base portion 165.

Of two main frames of a +Y side frame portion of the movable base portion 165, the main frame at the −Y side shall be represented by 165L and the main frame at the +Y side shall be represented by 165H.

As shown in FIG. 8, a +X side end of the main frame 165L is free. A +X side end of the main frame 165H is linked to a +Y side end portion of a +X side frame portion of the movable base portion 165. That is, a +X side end of the +Y side frame portion of the movable base portion 165 and the +Y side end portion of the +X side frame portion of the movable base portion 165 are linked directly without interposition of a spring portion. The structure that directly links the +X side end of the +Y side frame portion of the movable base portion 165 and the +Y side end portion of the +X side frame portion of the movable base portion 165 is an example of the “disabling structure” of the present disclosure.

Although not illustrated, a −X side end of the main frame 165L is free. Although not illustrated, a −X side end of the main frame 165H is linked to a +Y side end portion of a −X side frame portion of the movable base portion 165. That is, a −X side end of the +Y side frame portion of the movable base portion 165 and the +Y side end portion of the −X side frame portion of the movable base portion 165 are linked directly without interposition of a spring portion. The structure that directly links the −X side end of the +Y side frame portion of the movable base portion 165 and the +Y side end portion of the −X side frame portion of the movable base portion 165 is an example of the “disabling structure” of the present disclosure.

That is, in the first Z-axis offset detecting portion 109, a portion corresponding to the spring portion 67 of the first Z-axis sensor 9 is constituted of the main frame 165H of the movable base portion 165. A spring function of the spring portion 67 of the first Z-axis sensor 9 is thereby disabled in the first Z-axis offset detecting portion 109. A function of the movable electrodes displacing with respect to the fixed electrodes is thereby disabled. The movable electrodes therefore do not displace even when an acceleration in the Z-axis direction acts.

However, the movable electrodes undergo displacements in three-dimensional directions with respect to the fixed electrodes due to a stress (package stress) based on a temperature change. An acceleration in accordance with a displacement in the Z-axis direction among the displacements in three-dimensional directions is detected by the first Z-axis offset detecting portion 109. A first Z-axis offset amount for eliminating a temperature-change-based error from the output of the first Z-axis sensor 9 is thereby detected.

### [5.2] Second Z-Axis Offset Detecting Portion 110

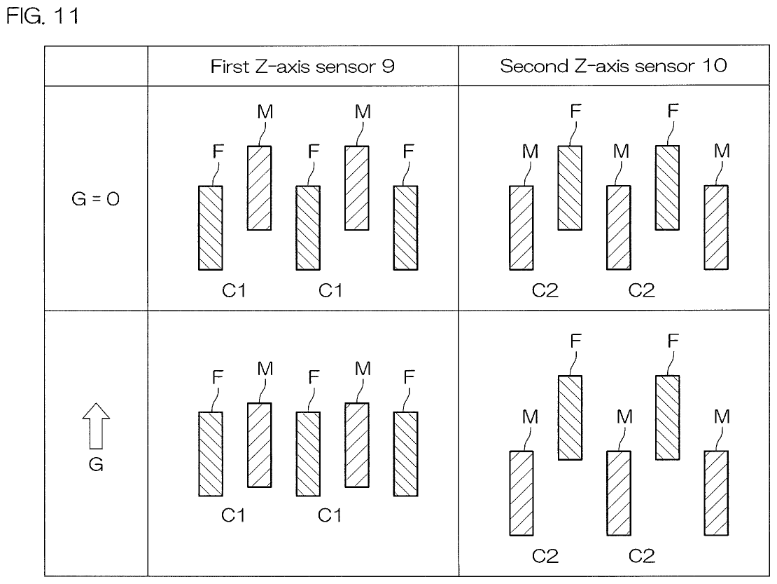

FIG. 10 is an enlarged plan view of principal portions of the second Z-axis offset detecting portion.

In FIG. 10, respective portions corresponding to those in FIG. 9 described above are indicated by attaching reference signs with which 100 is added to the reference signs in FIG. 9.

The second Z-axis offset detecting portion 110 has substantially the same arrangement as the second Z-axis sensor 10 being rotated by 1800 in plan view. However, the second Z-axis offset detecting portion 110 has a disabling structure that disables a function of movable electrodes (not shown) displacing with respect to fixed electrodes (not shown).

In the second Z-axis offset detecting portion 110, a plurality of the fixed electrodes are formed on an outer side wall of a −Y side frame portion of the fixed base 163 and a plurality of the movable electrodes are formed on an inner side wall of a −Y side frame portion of the movable base portion 165.

Of two main frames of a +Y side frame portion of the movable base portion 165, the main frame at the −Y side shall be represented by 165L and the main frame at the +Y side shall be represented by 165H.

As shown in FIG. 10, a +X side end of the main frame 165H is free. A +X side end of the main frame 165L is linked to a +Y side end portion of a +X side frame portion of the movable base portion 165. That is, a +X side end of the +Y side frame portion of the movable base portion 165 and the +Y side end portion of the +X side frame portion of the movable base portion 165 are linked directly without interposition of a spring portion. The structure that directly links the +X side end of the +Y side frame portion of the movable base portion 165 and the +Y side end portion of the +X side frame portion of the movable base portion 165 is an example of the “disabling structure” of the present disclosure.

Although not illustrated, a −X side end of the main frame 165H is free. Although not illustrated, a −X side end of the main frame 165L is linked to a +Y side end portion of a −X side frame portion of the movable base portion 165. That is, a −X side end of the +Y side frame portion of the movable base portion 165 and the +Y side end portion of the −X side frame portion of the movable base portion 165 are linked directly without interposition of a spring portion. The structure that directly links the −X side end of the +Y side frame portion of the movable base portion 165 and the +Y side end portion of the −X side frame portion of the movable base portion 165 is an example of the “disabling structure” of the present disclosure.

That is, in the second Z-axis offset detecting portion 110, a portion corresponding to the spring portion 67 of the second Z-axis sensor 10 is constituted of the main frame 165L of the movable base portion 165. A spring function of the spring portion 67 of the second Z-axis sensor 10 is thereby disabled in the second Z-axis offset detecting portion 110. A function of the movable electrodes displacing with respect to the fixed electrodes is thereby disabled. The movable electrodes therefore do not displace even when an acceleration in the Z-axis direction acts.

However, the movable electrodes undergo displacements in three-dimensional directions with respect to the fixed electrodes due to a stress (package stress) based on a temperature change. An acceleration in accordance with a displacement in the Z-axis direction among the displacements in three-dimensional directions is detected by the second Z-axis offset detecting portion 110. A second Z-axis offset amount for eliminating a temperature-change-based error from the output of the second Z-axis sensor 10 is thereby detected.

### [6] Effects, Etc., of the First Preferred Embodiment

With the first preferred embodiment described above, by offsetting the output of the X-axis sensor 7 using the X-axis offset amount detected by the X-axis offset detecting portion 107, the detection error, due to temperature change, of the X-axis direction acceleration can be reduced. Also, by offsetting the output of the Y-axis sensor 8 using the Y-axis offset amount detected by the Y-axis offset detecting portion 108, the detection error, due to temperature change, of the Y-axis direction acceleration can be reduced.

Also, by offsetting the output of the first Z-axis sensor 9 using the first Z-axis offset amount detected by the first Z-axis offset detecting portion 109 and offsetting the output of the second Z-axis sensor 10 using the second Z-axis offset amount detected by the second Z-axis offset detecting portion 110, the detection error, due to temperature change, of the Z-axis direction acceleration can be reduced.

Here, in the first preferred embodiment, the acceleration detecting portion 3 and the offset detecting portion 5 are formed using the same semiconductor substrate 2. However, the acceleration detecting portion 3 and the offset detecting portion 5 may instead be formed using different semiconductor substrates respectively.

### [7] Second Preferred Embodiment

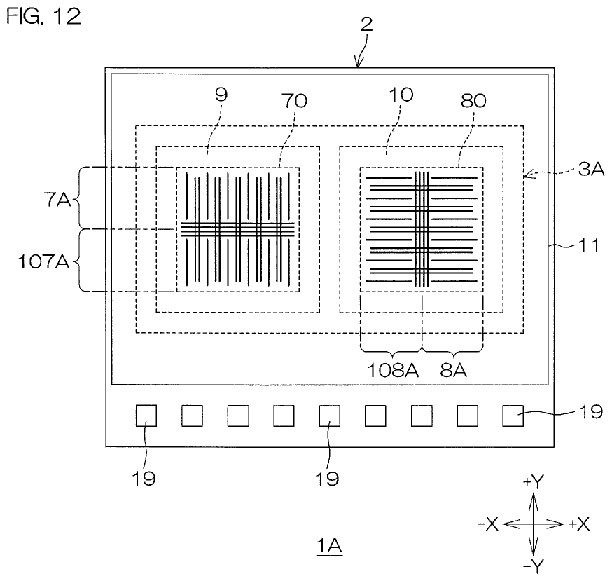

FIG. 12 is an illustrative plan view showing an acceleration sensor according to a second preferred embodiment of the present disclosure. In FIG. 12, portions corresponding to respective portions in FIG. 1 described above are indicated with the same reference signs attached as in FIG. 1.

An acceleration sensor 1A according to the second preferred embodiment includes a detecting portion 3A of quadrilateral shape in plan view that is disposed at a central portion of the semiconductor substrate 2, a plurality of electrode pads 19 that are disposed at the −Y side of the detecting portion 3A of the semiconductor substrate 2, and the lid 11 that covers the detecting portion 3A.

The detecting portion 3A includes a first region 70 of quadrilateral shape in plan view, a second region 80 of quadrilateral shape in plan view, the first Z-axis sensor 9, and the second Z-axis sensor 10. The first region 70 and the second region 80 are disposed side by side in the X-axis direction at an interval in the X-axis direction. The first Z-axis sensor 9 is disposed such as to surround the first region 70. The second Z-axis sensor 10 is disposed such as to surround the second region 80.

An X-axis sensor 7A and an X-axis offset detecting portion 107A are formed in the first region 70. A Y-axis sensor 8A and a Y-axis offset detecting portion 108A are formed in the second region 80.

The X-axis sensor 7A is formed in a +Y side half portion of the first region 70. The X-axis offset detecting portion 107A is formed in a −Y side half portion of the first region 70. The X-axis sensor 7A may have substantially the same arrangement as the arrangement of a +Y side half portion of the X-axis sensor 7 in the first preferred embodiment. The X-axis offset detecting portion 107A may have substantially the same arrangement as the arrangement of a −Y side half portion of the X-axis offset detecting portion 107 in the first preferred embodiment.

The Y-axis sensor 8A is formed in a +X side half portion of the second region 80. The Y-axis offset detecting portion 108A is formed in a −X side half portion of the second region 80. The Y-axis sensor 8A may have substantially the same arrangement as the arrangement of a +X side half portion of the Y-axis sensor 8 in the first preferred embodiment. The Y-axis offset detecting portion 108A may have substantially the same arrangement as the arrangement of a −X side half portion of the Y-axis offset detecting portion 108 in the first preferred embodiment.

With the second preferred embodiment, by offsetting an output of the X-axis sensor 7A using an X-axis offset amount detected by the X-axis offset detecting portion 107A, a detection error, due to temperature change, of an X-axis direction acceleration can be reduced. Also, by offsetting an output of the Y-axis sensor 8A using a Y-axis offset amount detected by the Y-axis offset detecting portion 108A, a detection error, due to temperature change, of a Y-axis direction acceleration can be reduced.

### [8] Third Preferred Embodiment

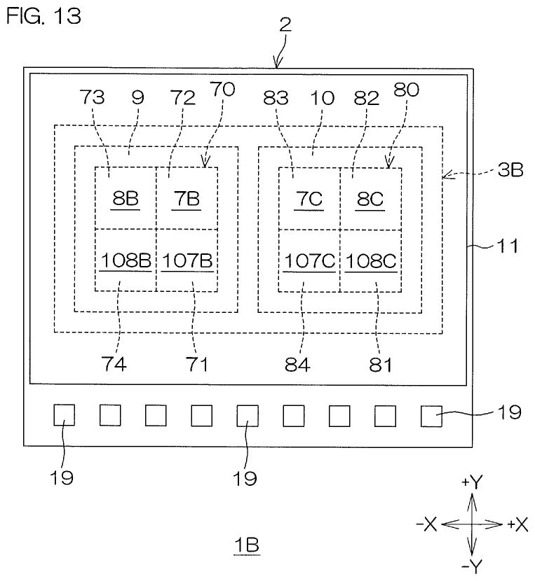

FIG. 13 is an illustrative plan view showing an acceleration sensor according to a third preferred embodiment of the present disclosure. In FIG. 13, portions corresponding to respective portions in FIG. 1 described above are indicated with the same reference signs attached as in FIG. 1.

An acceleration sensor 1B according to the third preferred embodiment includes a detecting portion 3B of quadrilateral shape in plan view that is disposed at a central portion of the semiconductor substrate 2, the plurality of electrode pads 19 that are disposed at the −Y side of the detecting portion 3B of the semiconductor substrate 2, and the lid 11 that covers the detecting portion 3B.

The detecting portion 3B includes the first region 70 of quadrilateral shape in plan view, the second region 80 of quadrilateral shape in plan view, the first Z-axis sensor 9, and the second Z-axis sensor 10. The first region 70 and the second region 80 are disposed side by side in the X-axis direction at an interval in the X-axis direction. The first Z-axis sensor 9 is disposed such as to surround the first region 70. The second Z-axis sensor 10 is disposed such as to surround the second region 80.

By the first region 70 being divided into two in each of the X-axis direction and the Y-axis direction, four divided regions 71 to 74 are formed inside the first region 70. The divided region at the +X side and −Y side shall be referred to as the first divided region 71, the divided region at the +X side and +Y side shall be referred to as the second divided region 72, the divided region at the −X side and +Y side shall be referred to as the third divided region 73, and the divided region at the −X side and −Y side shall be referred to as the fourth divided region 74.

A first X-axis sensor 7B is formed in the second divided region 72. A first X-axis offset detecting portion 107B arranged to detect a first X-axis offset amount with respect to the first X-axis sensor 7B is formed in the first divided region 71.

A first Y-axis sensor 8B is formed in the third divided region 73. A first Y-axis offset detecting portion 108B arranged to detect a first Y-axis offset amount with respect to the first Y-axis sensor 8B is formed in the fourth divided region 74.

By the second region 80 being divided into two in each of the X-axis direction and the Y-axis direction, four divided regions 81 to 84 are formed inside the second region 80. The divided region at the +X side and −Y side shall be referred to as the first divided region 81, the divided region at the +X side and +Y side shall be referred to as the second divided region 82, the divided region at the −X side and +Y side shall be referred to as the third divided region 83, and the divided region at the −X side and −Y side shall be referred to as the fourth divided region 84.

A second Y-axis sensor 8C is formed in the second divided region 82. A second Y-axis offset detecting portion 108C arranged to detect a second Y-axis offset amount with respect to the second Y-axis sensor 8C is formed in the first divided region 81.

A second X-axis sensor 7C is formed in the third divided region 83. A second X-axis offset detecting portion 107C arranged to detect a second X-axis offset amount with respect to the second X-axis sensor 7C is formed in the fourth divided region 84.

The first X-axis offset detecting portion 107B and the second X-axis offset detecting portion 107C may have the same arrangement as the X-axis offset detecting portion 107 of the acceleration sensor 1 according to the first preferred embodiment. The first Y-axis offset detecting portion 108B and the second Y-axis offset detecting portion 108C may have the same arrangement as the Y-axis offset detecting portion 108 of the acceleration sensor 1 according to the first preferred embodiment.

In the third preferred embodiment, an acceleration in the X-axis direction is detected based on a value with which an output of the first X-axis sensor 7B is offset using the first X-axis offset amount detected by the first X-axis offset detecting portion 107B and a value with which an output of the second X-axis sensor 7C is offset using the second X-axis offset amount detected by the second X-axis offset detecting portion 107C. A detection error, due to temperature change, of the acceleration in the X-axis direction can thereby be reduced.

Also, an acceleration in the Y-axis direction is detected based on a value with which an output of the first Y-axis sensor 8B is offset using the first Y-axis offset amount detected by the first Y-axis offset detecting portion 108B and a value with which an output of the second Y-axis sensor 8C is offset using the second Y-axis offset amount detected by the second Y-axis offset detecting portion 108C. A detection error, due to temperature change, of the acceleration in the Y-axis direction can thereby be reduced.

### [9] Fourth Preferred Embodiment

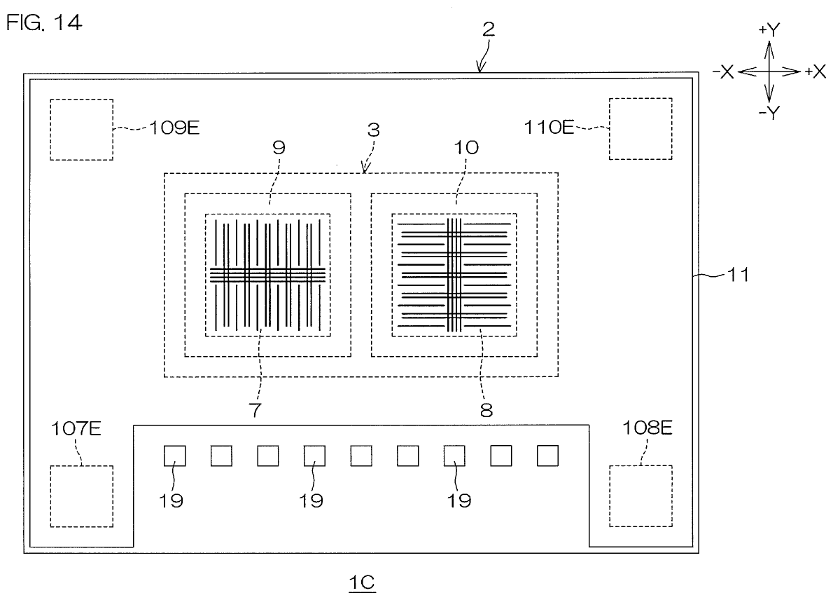

FIG. 14 is an illustrative plan view showing an acceleration sensor according to a fourth preferred embodiment of the present disclosure. In FIG. 14, portions corresponding to respective portions in FIG. 1 described above are indicated with the same reference signs attached as in FIG. 1.

An acceleration sensor 1C according to the fourth preferred embodiment includes the acceleration detecting portion 3 of quadrilateral shape in plan view that is disposed at a central portion of the semiconductor substrate 2, four offset detecting portions 107E to 110E that are disposed at four corner portions of the semiconductor substrate 2, and the plurality of electrode pads 19 that are disposed at the −Y side of the acceleration detecting portion 3 of the semiconductor substrate 2. The acceleration sensor 1C further includes the lid 11 that covers the detecting portion 3.

As with acceleration detecting portion 3 of the acceleration sensor 1 according to the first preferred embodiment, the acceleration detecting portion 3 includes the X-axis sensor 7, the Y-axis sensor 8, the first Z-axis sensor 9, and the second Z-axis sensor 10. The X-axis sensor 7 and the Y-axis sensor 8 are disposed side by side in the X-axis direction at an interval in the X-axis direction. The first Z-axis sensor 9 is disposed such as to surround the X-axis sensor 7. The second Z-axis sensor 10 is disposed such as to surround the Y-axis sensor 8.

The four offset detecting portions 107E to 110E include the X-axis offset detecting portion 107E, the Y-axis offset detecting portion 108E, the first Z-axis offset detecting portion 109E, and the second Z-axis offset detecting portion 110E.

The X-axis offset detecting portion 107E detects an X-axis offset amount with respect to the X-axis sensor 7. The Y-axis offset detecting portion 108E detects a Y-axis offset amount with respect to the Y-axis sensor 8. The first Z-axis offset detecting portion 109E detects a first Z-axis offset amount with respect to the first Z-axis sensor 9. The second Z-axis offset detecting portion 110E detects a second Z-axis offset amount with respect to the second Z-axis sensor 10.

The X-axis offset detecting portion 107E, the Y-axis offset detecting portion 108E, the first Z-axis offset detecting portion 109E, and the second Z-axis offset detecting portion 110E may have the same arrangements as the X-axis offset detecting portion 107, the Y-axis offset detecting portion 108, the first Z-axis offset detecting portion 109, and the second Z-axis offset detecting portion 110, respectively, of the acceleration sensor 1 according to the first preferred embodiment.

In the fourth preferred embodiment, a detection error, due to temperature change, of an acceleration in the X-axis direction can be reduced by offsetting the output of the X-axis sensor 7 using the X-axis offset amount detected by the X-axis offset detecting portion 107E. Also, a detection error, due to temperature change, of an acceleration in the Y-axis direction can be reduced by offsetting the output of the Y-axis sensor 8 using the Y-axis offset amount detected by the Y-axis offset detecting portion 108E.

Also, by offsetting the output of the first Z-axis sensor 9 using the first Z-axis offset amount detected by the first Z-axis offset detecting portion 109E and offsetting the output of the second Z-axis sensor 10 using the first Z-axis offset amount detected by the second Z-axis offset detecting portion 110E, a detection error, due to temperature change, of an acceleration in the Z-axis direction can be reduced.

While preferred embodiments of the present disclosure were described in detail above, these are merely specific examples used to clarify the technical contents of the present disclosure and the present disclosure should not be interpreted as being limited to these specific examples and the scope of the present disclosure is limited only by the appended claims.

1. An acceleration sensor comprising:
an acceleration detecting portion that detects an acceleration in a predetermined direction and an offset detecting portion that detects an offset amount with respect to the acceleration detecting portion; and
wherein the acceleration detecting portion includes
a first semiconductor substrate with a first cavity formed in its interior,
a first fixed structure including a first fixed electrode that is supported, in a state of floating with respect to the first cavity, by the first semiconductor substrate, and
a first movable structure including a first movable electrode that is supported, in a state of floating with respect to the first cavity, by the first semiconductor substrate via an elastic structure and is a first movable electrode displacing in the predetermined direction with respect to the first fixed electrode, and
the offset detecting portion includes
a second semiconductor substrate with a second cavity formed in its interior,
a second fixed structure including a second fixed electrode that is supported, in a state of floating with respect to the second cavity, by the second semiconductor substrate,
a second movable structure including a second movable electrode that is supported, in a state of floating with respect to the second cavity, by the second semiconductor substrate, and
a disabling structure that disables a function of the second movable electrode displacing with respect to the second fixed electrode.

2. The acceleration sensor according to claim 1, wherein the first semiconductor substrate and the second semiconductor substrate are arranged from a single semiconductor substrate that integrally includes the two and
the first cavity and the second cavity are formed in an interior of the single semiconductor substrate.

3. The acceleration sensor according to claim 1, wherein a shape and a size of the second fixed electrode are the same as a shape and a size of the first fixed electrode, and
a shape and a size of the second movable electrode are the same as a shape and a size of the first movable electrode.

4. The acceleration sensor according to claim 3, wherein the first fixed electrode includes a pair of first fixed electrodes that extend in parallel to each other at an interval in a predetermined direction, the first movable electrode includes a pair of first movable electrodes that are disposed between the pair of first fixed electrodes and extend in parallel to each other at an interval in the predetermined direction,
the second fixed electrode includes a pair of second fixed electrodes that extend in parallel to each other at an interval in the predetermined direction, and the second movable electrode includes a pair of second movable electrodes that are disposed between the pair of second fixed electrodes and extend in parallel to each other at an interval in the predetermined direction.

5. The acceleration sensor according to claim 3, wherein the first fixed electrode includes a plurality of first fixed electrodes that are formed in a comb-teeth shape in plan view,
the first movable electrode includes a plurality of first movable electrode pairs that are formed in a comb-teeth shape in plan view,
the plurality of first movable electrode pairs are disposed such as to contactlessly mesh with the plurality of first fixed electrodes,
each first movable electrode pair includes two of the first movable electrodes that respectively face the first fixed electrodes at respective sides of the first movable electrode pair and extend in parallel to each other,
the second fixed electrode includes a plurality of second fixed electrodes that are formed in a comb-teeth shape in plan view,
the second movable electrode includes a plurality of second movable electrode pairs that are formed in a comb-teeth shape in plan view,
the plurality of second movable electrode pairs are disposed such as to contactlessly mesh with the plurality of second fixed electrodes, and
each second movable electrode pair includes two of the second movable electrodes that respectively face the second fixed electrodes at respective sides of the second movable electrode pair and extend in parallel to each other.

6. The acceleration sensor according to claim 5, wherein the first fixed structure includes a first fixed base portion that is supported by the first semiconductor substrate and the plurality of first fixed electrodes that are formed in the comb-teeth shape with respect to the first fixed base portion,
the first movable structure includes a first movable base portion and the plurality of first movable electrode pairs that are formed in the comb-teeth shape with respect to the first movable base portion,
the first movable base portion is supported by the first fixed base portion via the elastic structure,
the second fixed structure includes a second fixed base portion that is supported by the second semiconductor substrate and the plurality of second fixed electrodes that are formed in the comb-teeth shape with respect to the second fixed base portion,
the second movable structure includes a second movable base portion and the plurality of second movable electrode pairs that are formed in the comb-teeth shape with respect to the second movable base portion, and
the second movable base portion is linked directly to the second fixed base portion.

7. The acceleration sensor according to claim 3, wherein the first fixed electrode includes a plurality of first fixed electrodes that are formed in a comb-teeth shape in plan view,
the first movable electrode includes a plurality of first movable electrodes that are formed in a comb-teeth shape in plan view,
the plurality of first movable electrodes are disposed such as to contactlessly mesh with the plurality of first fixed electrodes,
the second fixed electrode includes a plurality of second fixed electrodes that are formed in a comb-teeth shape in plan view,
the second movable electrode includes a plurality of second movable electrodes that are formed in a comb-teeth shape in plan view, and
the plurality of second movable electrodes are disposed such as to contactlessly mesh with the plurality of second fixed electrodes.

8. The acceleration sensor according to claim 7, wherein the first fixed structure includes a first fixed base portion that is supported by the first semiconductor substrate and the plurality of first fixed electrodes that are formed in the comb-teeth shape with respect to the first fixed base portion,
the first movable structure includes a first movable base portion and the plurality of first movable electrodes that are formed in the comb-teeth shape with respect to the first movable base portion,
the first movable base portion is supported by the first fixed base portion via the elastic structure,
the second fixed structure includes a second fixed base portion that is supported by the second semiconductor substrate and the plurality of second fixed electrodes that are formed in the comb-teeth shape with respect to the second fixed base portion,
the second movable structure includes a second movable base portion and the plurality of second movable electrodes that are formed in the comb-teeth shape with respect to the second movable base portion, and
the second movable base portion is linked directly to the second fixed base portion.

9. The acceleration sensor according to claim 1, wherein the acceleration detecting portion and the offset detecting portion each have a quadrilateral shape in plan view and
the offset detecting portion is disposed obliquely outward with respect to the acceleration detecting portion.

10. The acceleration sensor according to claim 1, wherein the acceleration detecting portion and the offset detecting portion each have a quadrilateral shape in plan view and
the offset detecting portion is disposed to face the acceleration detecting portion.

11. The acceleration sensor according to claim 2, wherein a shape and a size of the second fixed electrode are the same as a shape and a size of the first fixed electrode, and
a shape and a size of the second movable electrode are the same as a shape and a size of the first movable electrode.

12. The acceleration sensor according to claim 11, wherein the first fixed electrode includes a pair of first fixed electrodes that extend in parallel to each other at an interval in a predetermined direction, the first movable electrode includes a pair of first movable electrodes that are disposed between the pair of first fixed electrodes and extend in parallel to each other at an interval in the predetermined direction,
the second fixed electrode includes a pair of second fixed electrodes that extend in parallel to each other at an interval in the predetermined direction, and the second movable electrode includes a pair of second movable electrodes that are disposed between the pair of second fixed electrodes and extend in parallel to each other at an interval in the predetermined direction.

13. The acceleration sensor according to claim 11, wherein the first fixed electrode includes a plurality of first fixed electrodes that are formed in a comb-teeth shape in plan view,
the first movable electrode includes a plurality of first movable electrode pairs that are formed in a comb-teeth shape in plan view,
the plurality of first movable electrode pairs are disposed such as to contactlessly mesh with the plurality of first fixed electrodes,
each first movable electrode pair includes two of the first movable electrodes that respectively face the first fixed electrodes at respective sides of the first movable electrode pair and extend in parallel to each other,
the second fixed electrode includes a plurality of second fixed electrodes that are formed in a comb-teeth shape in plan view,
the second movable electrode includes a plurality of second movable electrode pairs that are formed in a comb-teeth shape in plan view,
the plurality of second movable electrode pairs are disposed such as to contactlessly mesh with the plurality of second fixed electrodes, and
each second movable electrode pair includes two of the second movable electrodes that respectively face the second fixed electrodes at respective sides of the second movable electrode pair and extend in parallel to each other.

14. The acceleration sensor according to claim 13, wherein the first fixed structure includes a first fixed base portion that is supported by the first semiconductor substrate and the plurality of first fixed electrodes that are formed in the comb-teeth shape with respect to the first fixed base portion,
the first movable structure includes a first movable base portion and the plurality of first movable electrode pairs that are formed in the comb-teeth shape with respect to the first movable base portion,
the first movable base portion is supported by the first fixed base portion via the elastic structure,
the second fixed structure includes a second fixed base portion that is supported by the second semiconductor substrate and the plurality of second fixed electrodes that are formed in the comb-teeth shape with respect to the second fixed base portion,
the second movable structure includes a second movable base portion and the plurality of second movable electrode pairs that are formed in the comb-teeth shape with respect to the second movable base portion, and
the second movable base portion is linked directly to the second fixed base portion.

15. The acceleration sensor according to claim 11, wherein the first fixed electrode includes a plurality of first fixed electrodes that are formed in a comb-teeth shape in plan view,
the first movable electrode includes a plurality of first movable electrodes that are formed in a comb-teeth shape in plan view,
the plurality of first movable electrodes are disposed such as to contactlessly mesh with the plurality of first fixed electrodes,
the second fixed electrode includes a plurality of second fixed electrodes that are formed in a comb-teeth shape in plan view,
the second movable electrode includes a plurality of second movable electrodes that are formed in a comb-teeth shape in plan view, and
the plurality of second movable electrodes are disposed such as to contactlessly mesh with the plurality of second fixed electrodes.

16. The acceleration sensor according to claim 15, wherein
the first fixed structure includes a first fixed base portion that is supported by the first semiconductor substrate and the plurality of first fixed electrodes that are formed in the comb-teeth shape with respect to the first fixed base portion,
the first movable structure includes a first movable base portion and the plurality of first movable electrodes that are formed in the comb-teeth shape with respect to the first movable base portion,
the first movable base portion is supported by the first fixed base portion via the elastic structure,
the second fixed structure includes a second fixed base portion that is supported by the second semiconductor substrate and the plurality of second fixed electrodes that are formed in the comb-teeth shape with respect to the second fixed base portion,
the second movable structure includes a second movable base portion and the plurality of second movable electrodes that are formed in the comb-teeth shape with respect to the second movable base portion, and
the second movable base portion is linked directly to the second fixed base portion.
